(19) United States
(12) Patent Application Publication
(10) Pub. No.: US 2003/0046375 A1
(43) Pub. Date: Mar. 6, 2003

(54) Distributed database control for fault tolerant initialization

(76) Inventors: David S. Parkman, Mercer Island, WA (US); Gary V. Stephenson, Bellevue, WA (US)

Correspondence Address: HARNESS, DICKEY & PIERCE, P.L.C., P.O. BOX 828, BLOOMFIELD HILLS, MI, 48303, US

(21) Appl. No.: 10/054,839

(22) Filed: Jan. 22, 2002

Related U.S. Application Data
(60) Provisional application No. 60/316,846, filed on Aug. 31, 2001.

(51) Int. Cl. G06F 15/177

(52) U.S. Cl. 709/220

(57) ABSTRACT

A network for a mobile platform includes first and second servers that provide first and second services and include a first and second configuration databases, respectively. If both of the first and second servers successfully boot up and complete self-testing, the first and second servers compare the first and second configuration databases. If the first and second configuration databases do not match, one of the first and second configuration databases having an older update date is replaced with the other of the first and second configuration databases having a newer update date. The first server to boot up and complete self-testing is designated a primary server that tracks network status. If the first (or second) server does not boot up and complete self-testing, the second (or first) server performs a subset of the first (or second) service.

### FIELD OF THE INVENTION

The present invention relates to networks, and more particularly to networks on board mobile platforms.

### BACKGROUND OF THE INVENTION

Broadband communications access, on which our society and economy is growing increasingly dependent, is not readily available to users on board mobile platforms such as aircraft, ships, and trains. While the technology exists to deliver the broadband communications services to mobile platforms, conventional solutions are commercially unfeasible due to the high costs or low data rates. The conventional solutions have therefore only been available to government/military users and/or to high-end maritime markets such as cruise ships.

Networks on board mobile platforms typically include one or more servers. For example, the network may include a data transceiver router (DTR) server, a media server, and a web server. Each of the servers must be powered on, booted up and properly initialized. If one or more of the servers fails to boot up properly or is late in booting up, problems can arise. For example, the failed server may provide a necessary communication function or other service.

### SUMMARY OF THE INVENTION

A network for a mobile platform according to the invention includes a first server that provides a first service and includes a first configuration database. A second server is connected to the first server, provides a second service and includes a second configuration database. If both of the first and second servers successfully boot up and complete self-testing, the first and second servers compare the first and second configuration databases.

In other features of the invention, if the first and second configuration databases do not match, one of the first and second configuration databases having an older update date is replaced with the other of the first and second configuration databases having a newer update date.

In still other features of the invention, a first of the first and second servers to boot up and complete self-testing is designated a primary server. The primary server tracks network status.

In still other features of the invention, if the first server does not boot up and complete self-testing, the second server performs a subset of the first service. Alternately, if the second server does not boot up and complete self-testing, the first server performs a subset of the second service.

In yet other features of the invention, a third server, connected to the first and second servers, provides a third service and includes a third configuration database. The mobile platform is an aircraft and one of the first, second and third servers is a web server, a media server, or a data transceiver server.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A is a schematic block diagram of a mobile platform network;

FIG. 1B is a schematic block diagram illustrating a seat electronic box (SEB) in further detail;

FIG. 1C is a schematic block diagram of the router processor card;

FIG. 2 is a flowchart illustrating steps of a boot sequence according to the present invention;

FIG. 3 is a flowchart illustrating steps performed during LRU initialization;

FIG. 4 is a flowchart illustrating steps performed during mobile platform electronics subsystem (MPES) initialization;

FIG. 5 is a flowchart illustrating steps performed to render the MPES operational;

FIG. 6 is a flowchart illustrating steps performed to update the configuration database;

FIG. 7 is a N-squared chart showing state transitions and initialization;

FIG. 8 illustrates MPES initialization use case scenario; and

FIG. 9 illustrates MPES data structures that are required for initialization.

### DETAILED DESCRIPTION OF THE PREFERRED EMBODIMENTS

The following description of the preferred embodiment(s) is merely exemplary in nature and is in no way intended to limit the invention, its application, or uses.

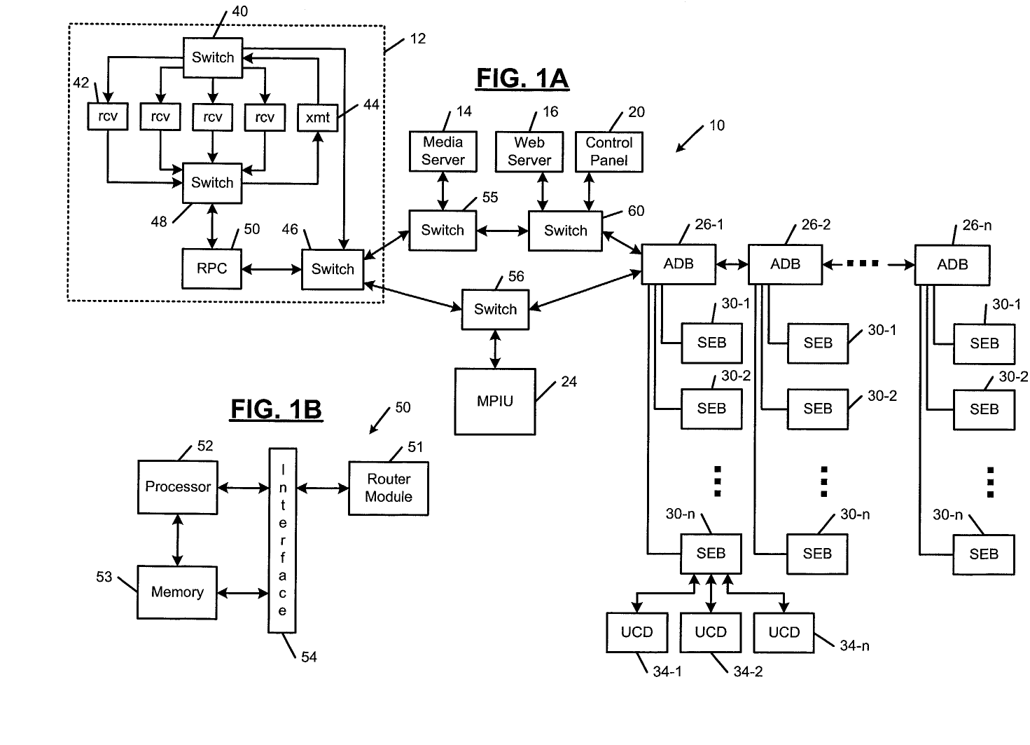

Referring now to FIGS. 1A, 1B and 1C, a mobile platform electronic system 10 is illustrated. The MPES 10 includes a data transceiver (DTR) server 12, a media server 14, and a web server 16. The mobile platform network 10 further includes a control panel 20, an aircraft interface unit (AIU) 24 and one or more area distribution boxes (ADBs) 26-1, 26-2, . . . , 26-n. The ADBs 26 are connected to one or more seat electronic boxes (SEB) 30-1, 30-2, . . . , 30-n. The SEB 30 are connected to one or more user communication devices 34-on, 34-2, . . . , 34-n.

The DTR server 12 includes a switch 40 that relays data between an antenna system (not shown), receivers 42, a transmitter 44 and a switch 46. A switch 48 relays data between the receivers 42, the transmitter 44 and a router processor card (RPC) 50. The RPC includes a router 51, a processor 52, a memory 53 (such as read only memory, random access memory, flash memory, etc.) and an input/output interface that are packaged on a card. Skilled artisans will appreciate that the processor 52, memory 53 and I/O interface 54 can be packaged separately from the router 51. The switch 46 relays data between the switch 40, the router 50, a switch 55 and a switch 56. The switch 54 is also connected to the media server 14 and to a switch 60. The switch 56 is also connected to the AIU 24 and one or more all of the ADBs 26. The switch 60 is connected to the web server 16, the control panel 20, and one or more of the ADBs 26. The SEB 30 includes a switch 64 and a seat processor 66. The switch 64 is connected to the ADB 26. The seat processor 66 is connected to one or more of the UCDs 34.

A fault tolerant initialization method according to the present invention provides fault-tolerant system initialization for the MPES 10. The fault tolerant initialization method for the MPES 10 directs a sequence of events that is necessary to bring the MPES 10 from a power-off state to an operational state. The fault tolerant initialization method depends on only one of three Line Replaceable Units (LRUs) or servers booting up to an operational state. In the MPES 10, the DTR server 12, the media server 14 and the web server 16 will be referred to as LRUs. Skilled artisans will appreciate that additional servers or LRUs may be employed without departing from the present invention.

Power is initially applied to all of the LRUs in the MPES 10 simultaneously. The LRUs (for example the DTR server 12, the media server 14, and the web server 16) boot up. The LRUs store copies of a configuration database (CDB) that contains configuration information such as router settings, hardware settings, software settings, tail notch information (for aircraft), etc. One LRU provides backup to other LRUs in the event that the other LRU boots up late or fails to boot up.

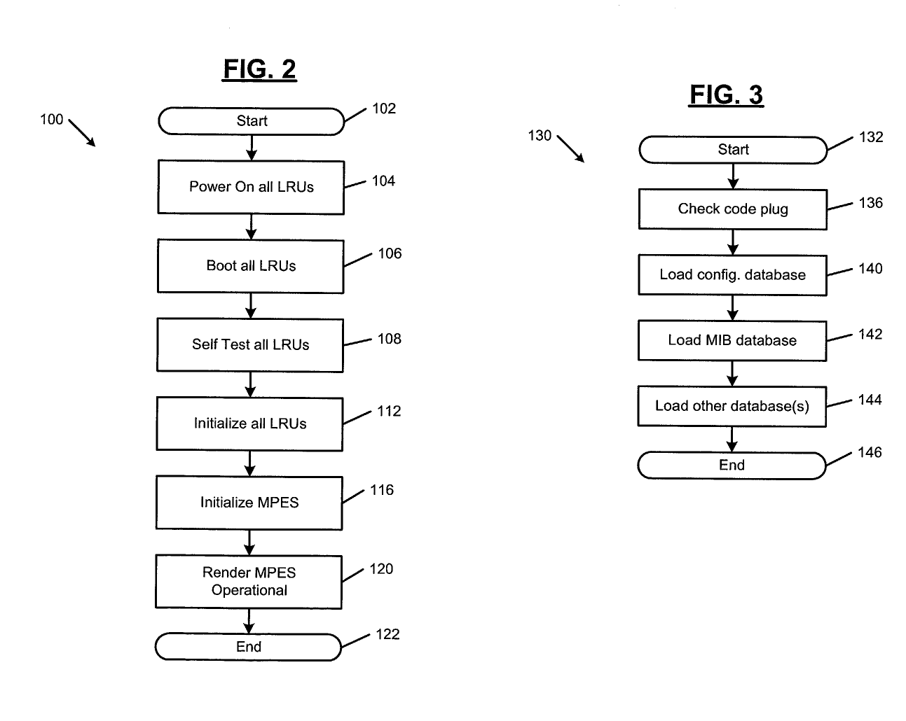

Referring now to FIG. 2, a boot sequence 100 is illustrated. Control begins with step 102. In step 104, all of the LRUs are powered on. In step 106, all of the LRUs are booted up. In step 108, all of the LRUs are self tested. In step 112, all of the LRUs are initialized. In step 116, the MPES is initialized. In step 120, the MPES 10 is rendered operational. Control ends with step 122.

Referring now to FIG. 3, steps performed during initialization of the LRUs are shown at 130. Control begins with step 132. In step 136, a code plug is checked. In step 140, the CDB is loaded. In step 142, a management information database (MIB) is loaded. In step on 44, other databases are also loaded. Control ends with step 146.

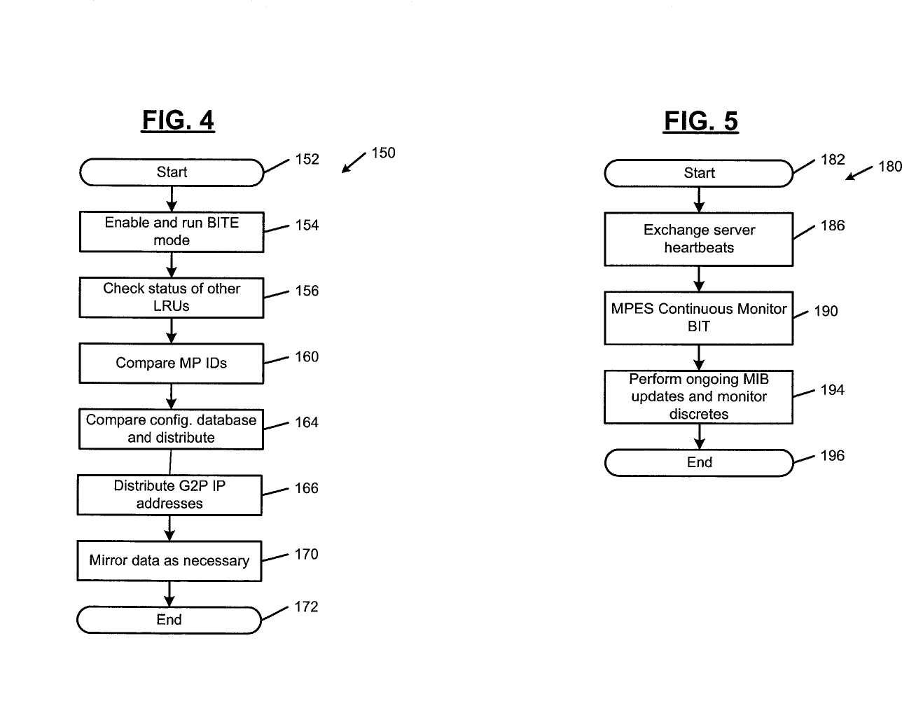

Referring now to FIG. 4, steps performed to initialize the MPES 10 are shown at 150. Control begins with step 152. In step 154, a built-in test equipment (BITE) mode is enabled and run. When the MPES 10 is associated with aircraft, the BITE mode can only be enabled when the aircraft is on the ground. In step 156, the status of other LRUs is checked. In step 160, MP IDs are checked. In step 164, CDBs are compared and distributed. In step 166, ground to platform (G2P) IP addresses are distributed. In step 170, data is mirrored as necessary. Control ends in step 172.

Referring now to FIG. 5, steps performed to render the MPE operational are shown at 180. Control begins with step 182. In step 186, server heartbeats are exchanged. In step 190, a fault manager begins performing MPES Continuous Monitor built-in test (BIT). In step 194, ongoing MIB updates are performed and discretes are monitored. Control ends with step 196.

Initialization involves the process of achieving an operational state. The first step of initialization is to power up the MPES 10 to begin a boot process. The boot process consists of all LRUs containing CPUs loading and running operational software to the point where a self-test is commanded. If at least one LRU is in the self-test mode, the MPE is in self-test mode. When all LRUs have completed self-test successfully (and the DTR server, web server and media server have loaded the CDB and MIB), the LRUs are in an operational state. The MPE subsystem is operational when all of the LRUs have reached an operational state.

The first server that enters an operational state is defined as the primary server. The primary server determines the mobile platform ID from its shorting plug or ID plug. The primary server maintains MPES status. In other words, the primary server tracks the state of the MPES. Part of the task of tracking the state of the MPES involves monitoring the status of individual LRUs. LRUs status is tracked by polling for status, by checking other LRU MIBs, and by monitoring heartbeat messages sent by the DTR server and the other server. Each server is capable of tracking the state of the MPES, defining what constitutes a state transition from one state to another, and determining the state of the MPES.

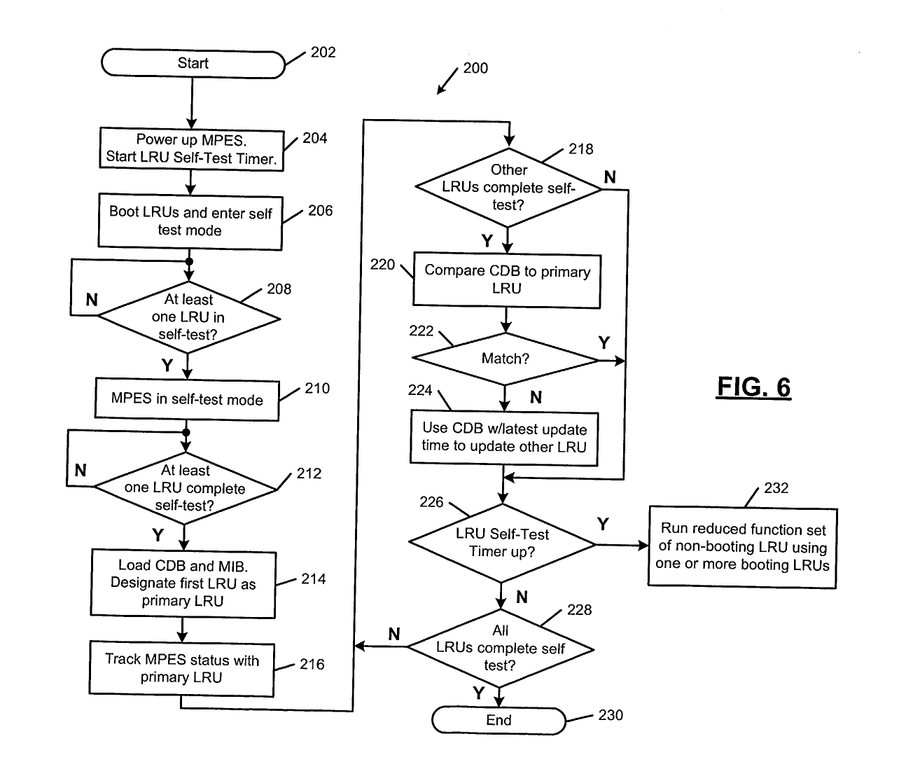

Referring now to FIG. 6, the initialization method is illustrated in further detail and is generally designated 200. Control begins with step 202. In step 204, the MPES is powered up and an LRU boot timer is started. In step 206, the LRUs are booted and enter a self-test mode. In step 208, control determines if at least one LRU is in self-test mode. If not, control loops back to step 208. Otherwise, control continues with step 210 where the MPES is now considered in self-test mode. In step 212, control determines if at least one LRU completes self-test. If not, control loops back to step 212. Otherwise, control continues with step 214. In step 214, control loads the CDB and MIB and designates the first LRU as the primary LRU. In step 216, the primary server tracks MPES status using the primary LRU.

In step 218, control determines whether other LRUs have completed self-test. If other LRUs have completed self-test, control continues with step 220 where CDBs of the primary LRU and the other LRU are compared. In step 222, control determines whether there is a match. If not, control continues with step 224 where control uses the CDB having the latest update time to update the other CDB. In step 226, control determines whether the LRU boot timer is up. If not, control determines whether all of the LRUs have completed self test in step 228. If not, control continues with step 218. Otherwise, control and is with step 230. If the boot timer is up as determined in step 226, control runs a reduced function set of the non-booting LRU(s) using one or more LRUs that have completed boot up and self-test.

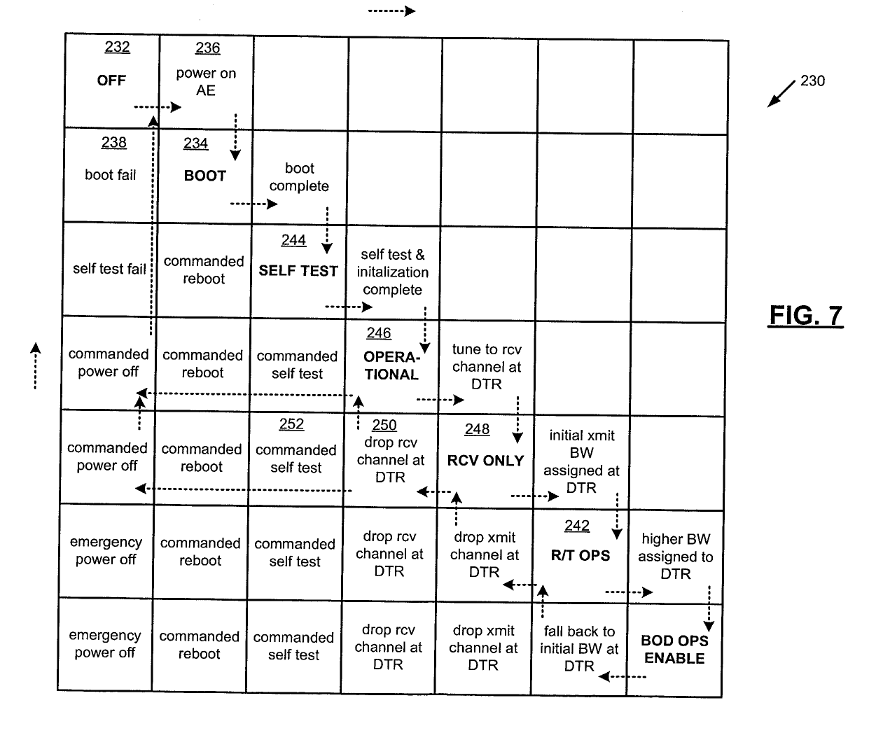

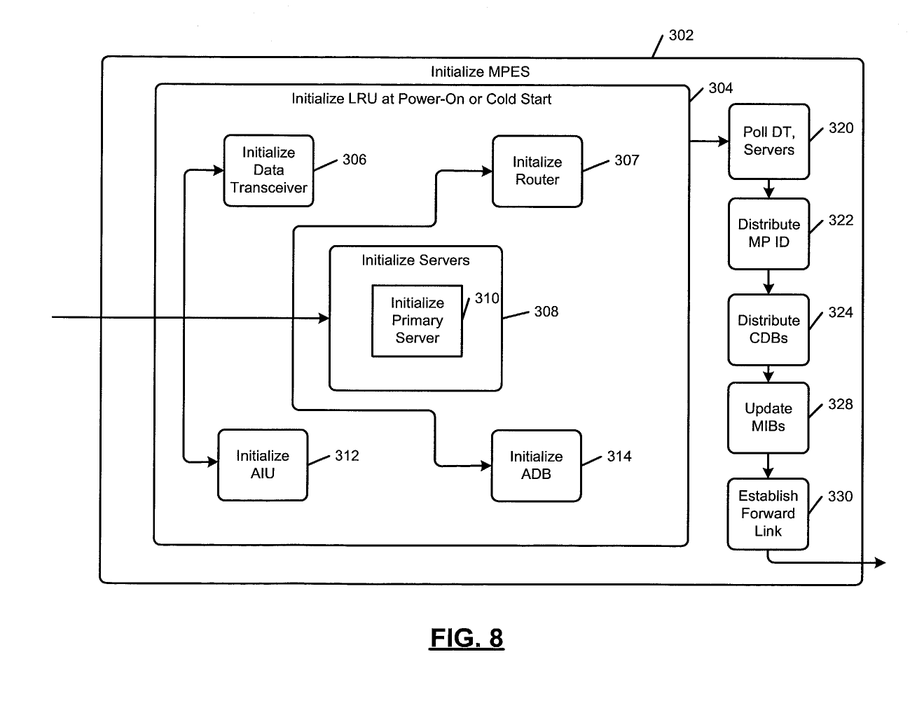

Referring now to FIG. 7, an N-squared chart is shown at 230. The chart 230 lists states along a diagonal of the chart 230 and command sequences to transition from one state to the next in non-diagonal squares. Moving clockwise from one diagonal square to the next diagonal square identifies condition(s) that are required to transition to the next state. Moving clockwise from one diagonal square to a prior diagonal square identifies one or more conditions that are required to reach a prior state. For example, the MPES must be powered on to move from an off state 232 to a boot state 234 as identified at block 236. To move from the boot state 234 to the off state 232, the boot must fail as identified at block 238.

As can be appreciated from FIG. 7, to move from the off state 232 to a receive/transmit operational state 242, the initialization sequence must achieve intermediate states including a self-test state 244, an operational state 246, and a receive only state 248. In contrast, moving from the receive-only state 248 to the self-test state 244 can be performed without achieving the intermediate states. In this example, to move from the receive only state 248 to the self-test state 244, the receiver channel must be dropped at the DTR (at 250) and a commanded self test (at 254) performed. Skilled artisans will appreciate that the transitions between other states can be derived from FIG. 7.

Upon completion of the boot up sequence, the DTR server 12, media server 14, and the web server 16 attempt to read and use their CDBs to configure the system for operational use. CDBs are compared by the primary server to ensure that they match. If they do not match, the server having the CDB with the latest update time will be used by the primary server to update the other CDBs in the non-primary servers.

After the MPES has entered an operational state, the DTR server 12 checks a tuning database for the forward link (FL) receiver tune defaults. The DTR server 12 tunes to the channels designated by the tuning database and begins receiving data from the forward transponder. As soon as the DTR server 12 receives its first heartbeat message, the DTR server 12 is in a receive state. Once the DTR server 12 is in a receive state, the overall MPES achieves the receive-only state. The MPES is ready to receive return channel commands. When the first return link assignment is claimed by the DTR server 12 and the return link becomes operational, the MPES is in the receive/transmit state.

When the DTR server 12 requests and is granted additional bandwidth for the return link, the DTR server 12 and the MPES enters the DAMA operations state. Bandwidth requirements are monitored and bandwidth is returned when it is no longer needed until the maximum bandwidth is achieved. At this point, the MPES has returned to fixed bandwidth R/T operations. As can be appreciated from FIG. 7, normally the MPES drops the return channel when it is no longer needed. The MPES will then be commanded off and return to the power off state.

During initialization, the mobile platform network 10 becomes operational over the command and control CCN subnetwork. While the CCN subnetworks are identical for each mobile platform, the air to ground (A2G) subnet addressing is different for each mobile platform. The A2G subnet IP addresses are not available until after the mobile platform network 10 is up and the LRUs have had access to one or more of the CDBs to discover their address on the CCN subnet. The processor in the DTR server 12 stores the A2G IP addresses in a database.

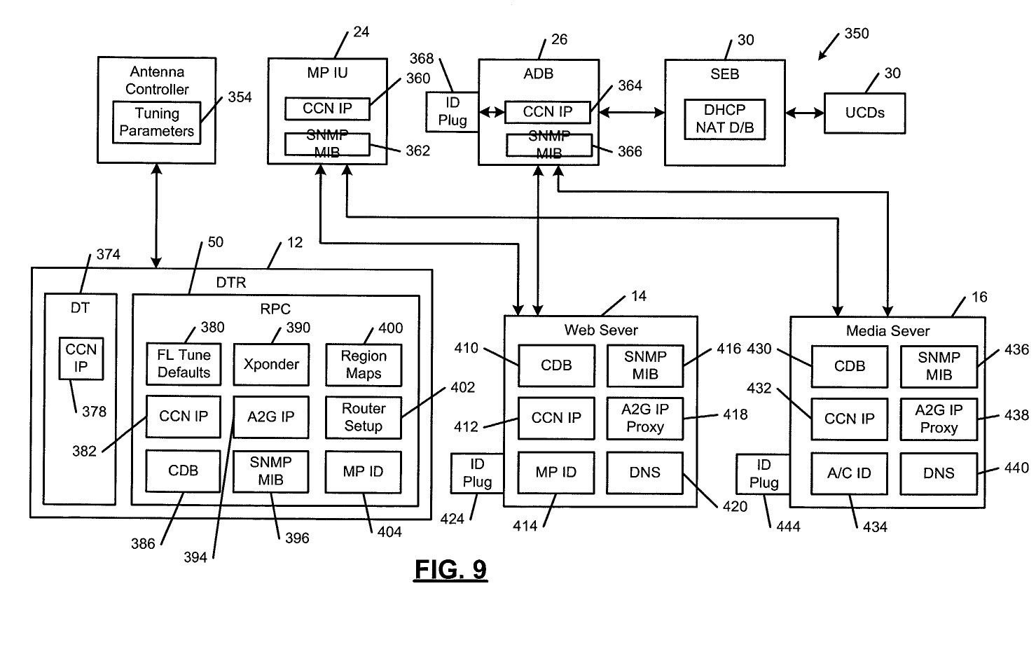

Referring now to FIG. 8, an MPES initialization use case scenario is illustrated at 300. The use case scenario includes the necessary preconditions, steps and post conditions that constitute the MPES initialization sequence and the various relationships between steps. Initially, the MPE segment is initialized at step 302. Then, LRU at power-on are initialized at step 304. The data transceiver is initialized at step 306. The router is initialized at step 307 and the servers are initialized at step 308. The primary server is initialized at step 310. The AIU is initialized at step 312. The ADB is initialized at step 314. Subsequently, the data transceiver and servers are polled in step 320. In step 322, a mobile platform (MP) ID is distributed. At step 324, CDBs are distributed. In step 328, MIBs are updated. In step 330, a forward link is established.

Referring now to FIG. 9, data structures for devices that are associated the MPES are shown and are generally designated 350. An antenna controller 352 includes tuning parameters 354 for receive and transmit antennas (not shown). In a preferred mode, the antenna is a spatial phased array antenna. The AIU 24 includes a command and control network (CCN) Internet protocol (IP) 360 and a simple network management protocol (SNMP) management information database (MIB) 362. The ADB 26 includes CCN IP 364, SNMP MIB 366 and an ID plug 368. The SEB 30 includes a dynamic host control protocol (DHCP) network address translation (NAT) database 370.

The DTR server 12 includes the data transceiver (DT) 374 and the RPC 50. A CCN IP 378 data structure is associated with the DT 374. The RPC 50 is associated with forward link tune defaults 380, CCN IP 382, CDB 386, transponder defaults 390, A2G IP address 394, SNMP MIB 396, region maps 400, router setup 402 and MP ID 404 data structures. The region maps include one or more look-up tables (LUTs) for local satellites in the area where the mobile platform is located. The location of the mobile platform may be derived from navigational electronics that are associated with the mobile platform. The mobile platform attempts to initiate communications with transponders that are associated with a first or priority satellite. If the mobile platform is unable to establish communications, the mobile platform attempts to contact transponders of lower priority satellites in the LUT.

The web server 14 includes CDB 410, CCN IP 412, MP ID 414, SNMP MIB 416, A2G IP proxy 418, and domain name server (DNS) data structures 420. The web server 16 also has an ID plug 424. The media server 16 includes CDB 430, CCN IP 432, MP ID 434, SNMP MIB 416, A2G IP proxy 438, and DNS data structures 440. The web server 16 also has an ID plug 424.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A network for a mobile platform, comprising:
a first server that provides a first service and includes a first configuration database;
a second server, connected to said first server, that provides a second service and includes a second configuration database,
wherein when said first and second servers boot up, said first and second servers compare said first and second configuration databases.

2. The network of claim 1 wherein said comparison occurs after boot up and self-testing.

3. The network of claim 1 wherein if said first and second configuration databases do not match, one of said first and second configuration databases having an older update date is replaced with the other of said first and second configuration databases having a newer update date.

4. The network of claim 3 wherein a first of said first and second servers to boot up and complete self-testing is designated a primary server.

5. The network of claim 4 wherein said primary server tracks network status.

6. The network of claim 3 wherein if said first server does not boot up and complete self-testing, said second server performs a subset of said first service.

7. The network of claim 3 wherein if said second server does not boot up and complete self-testing, said first server performs a subset of said second service.

8. The network of claim 1 further comprising:
a third server, connected to said first and second servers, that provides a third service and includes a third configuration database.

9. The network of claim 8 wherein said mobile platform is an aircraft and one of said first, second and third servers is a web server.

10. The network of claim 8 wherein said mobile platform is an aircraft and one of said first, second and third servers is a media server.

11. The network of claim 8 wherein said mobile platform is an aircraft and one of said first, second and third servers is a data transceiver server.

12. A method for initializing a network for a mobile platform, comprising:
connecting first and second servers;
powering on said first and second servers;
providing a first service with said first server that includes a first configuration database;
providing a second service with said second server that includes a second configuration database;
comparing said first and second configuration databases when said first and second servers boot up and complete self-testing.

13. The method of claim 12 further comprising the step of:
if said first and second configuration databases do not match, replacing one of said first and second configuration databases having an older update date with the other of said first and second configuration databases having a newer update date.

14. The method of claim 13 further comprising the step of:
designating a first of said first and second servers to boot up and complete self-testing as a primary server.

15. The method of claim 14 further comprising the step of:
tracking network status using said primary server.

16. The method of claim 12 further comprising the step of:
performing a subset of said first service using said second server if said first server does not boot up and complete self-testing.

17. The method of claim 12 further comprising the step of:
performing a subset of said second service using said first server if said second server does not boot up and complete self-testing.

18. The method of claim 12 further comprising:
connecting a third server to said first and second servers, wherein said third server provides a third service and includes a third configuration database.

19. The method of claim 18 wherein one of said first, second and third servers is a web server.

20. The method of claim 18 wherein one of said first, second and third servers is a media server.

21. The method of claim 18 wherein one of said first, second and third servers is a data transceiver server.
